(19) United States
(12) Patent Application Publication
(10) Pub. No.: US 2009/0315338 A1
(43) Pub. Date: Dec. 24, 2009

(54) Mobile Energy Systems and Methods

(76) Inventor: Carl Ylvisaker, Redmond, OR (US)

Correspondence Address: Mohr Intellectual Property Law Solutions, P.C., 16814 NW Oak Creek Dr., Beaverton, OR, 97006, US

(21) Appl. No.: 12/487,597

(22) Filed: Jun. 18, 2009

Related U.S. Application Data
(60) Provisional application No. 61/132,563, filed on Jun. 18, 2008.

(51) Int. Cl. H02K 7/18

(52) U.S. Cl. 290/1 R

(57) ABSTRACT

Mobile energy systems including a frame, an axle supported by the frame, a wheel mounted to the axle and in contact with the ground, the wheel being configured rotate about the axle when the frame translates relative to the ground, an energy storage device supported by the frame, and an electricity generator operatively connected to the wheel and electrically connected to the energy storage device, the electricity generator being driven by rotation of the wheel and generating electricity when driven. Mobile energy methods including rotating a wheel by moving it along the ground, producing electricity as the wheel rotates by driving an electricity generator, and storing at least a portion of the electricity produced by the electricity generator in an energy storage device.

### CROSS REFERENCE TO RELATED APPLICATIONS

This application claims the benefit of copending U.S. Provisional Application, Ser. No. 61/132,563, filed on Jun. 18, 2008, which is hereby incorporated by reference for all purposes.

### BACKGROUND

The present disclosure relates generally to mobile energy systems and methods. Mobile energy systems and methods involve generating electricity to store for later use or to power electrical devices. Mobile energy systems and methods are useful to supplement or to serve in place of power supplied by local utilities over wired electrical grids.

Mobile energy is necessary in locations not supplied with electricity by local utilities. For example, camp sites, rural areas, and remote villages may not be connected to existing power grid infrastructure. There exists a need to supply electricity to locations not connected to energy utilities.

Even in areas connected to local energy utilities, mobile energy is desirable to supplement the energy supplied by local utilities. The capacity of local utilities does not always keep up with demand. Further, energy utilities sometimes require energy consumers to limit or modify their energy usage. For example, consumers may be instructed to not run air conditioners or to turn off power for certain periods of the day to accommodate periods of peak demand. Further, areas affected by natural disasters or acts of war or terrorism require mobile energy to supply electrical power. For example, conventional sources of mobile energy, like fuel powered generators, are indispensable to hospitals during power outages.

Moreover, mobile energy systems and methods provide alternative sources of power to users. Electricity consumers are often concerned about be the cost of energy supplied by energy utilities or concerned about the environmental impact associated with how the electricity is generated by energy utilities. A consumer's ability to create his own electricity independent of an energy utility provides him with freedom and flexibility.

Conventional mobile energy systems generate electricity by a variety of means. Some conventional mobile energy systems combust a fuel, such as gasoline, kerosene, or fuel oil, to create mechanical energy, which is converted into electrical energy. Other conventional mobile energy systems utilize fuel cells to create electrical energy from a supply of hydrogen. Still other conventional mobile energy systems utilize solar energy to generate electrical energy.

However, conventional mobile energy systems have certain limitations that render them unsatisfactory for certain applications. For example, conventional mobile energy systems are often large and cumbersome, making them difficult to transport from one location to another. Further, conventional mobile energy systems are not configured to attach to a transport, such as a vehicle, an animal, or a person, to be towed by the transport. Moreover, conventional mobile energy systems known in the art are not configured to utilize the motion of a towed wheel to generate electricity. Thus, there exists a need for improved mobile energy systems and methods.

Indeed, conventional mobile energy systems do not provide convenient power solutions for trips to remote locations, such as camp sites, or for allowing a home to become energy independent of grid-based electricity utilities. When camping, a camper may desire to have a source of electricity available to him at the campsite. A mobile energy system that could easily be towed to the campsite, generating and storing electricity while en route, would provide a convenient source of power to the camper. Similarly, a mobile energy system that could generate and store sufficient electricity during normal daily trips to fully power a home would provide a homeowner with a convenient source of power.

Disclosure addressing one or more of the identified existing needs is provided in the detailed description below. Examples of references relevant to mobile energy systems and methods include U.S. Pat. Nos. 3,281,161, 4,314,160, 5,178,403, 5,215,156, 5,488,287, 5,767,663, and 6,133,659. The complete disclosures of the above patents and patent applications are herein incorporated by reference for all purposes.

### SUMMARY

The present disclosure is directed to mobile energy systems and methods. Mobile energy systems include a frame, an axle supported by the frame, a wheel mounted to the axle and in contact with the ground, the wheel being configured rotate about the axle when the frame translates relative to the ground, an energy storage device supported by the frame, and an electricity generator operatively connected to the wheel and electrically connected to the energy storage device, the electricity generator being driven by rotation of the wheel and generating electricity when driven.

Mobile energy methods include rotating a wheel by moving it along the ground, producing electricity as the wheel rotates by driving an electricity generator, and storing at least a portion of the electricity produced by the electricity generator in an energy storage device.

### BRIEF DESCRIPTION OF THE DRAWINGS

FIG. 1 is a perspective view of a mobile energy system attached to a transport.

FIG. 2 is a side view of the mobile energy system shown in FIG. 1 showing a wheel pivoting up and down about a horizontal shaft supported by a bearing.

FIG. 3 is a perspective view of an example of a mobile energy system including two wheels.

FIG. 4 is a flowchart of a mobile energy method for generating and storing electricity.

FIG. 5 is a flowchart of a mobile energy method for distributing electricity.

### DETAILED DESCRIPTION

The disclosed mobile energy systems and methods will become better understood through review of the following detailed description in conjunction with the drawings and the claims. The detailed description, drawings, and claims provide merely examples of the various inventions described herein. Those skilled in the art will understand that the disclosed examples may be varied, modified, and altered without departing from the scope of the inventions as defined in the claims, and all equivalents to which they are entitled. Many variations are contemplated for different applications and design considerations; however, for the sake of brevity, each and every contemplated variation is not individually described in the following detailed description.

Throughout the following detailed description, a variety of mobile energy system and method examples are provided. Related reference numbers (e.g., 12, 112, 212) will be used for related features in each example. Related features may be identical, similar, or dissimilar in different examples. For the sake of brevity, related features will not be redundantly explained in each example. Instead, the use of related numbers will cue the reader that the feature with a related number may be similar to the related feature in an example explained previously. Features specific to a given example will be described in that particular example. The reader should understand that a given feature need not be the same or similar to the specific portrayal of a related feature in any given figure or example.

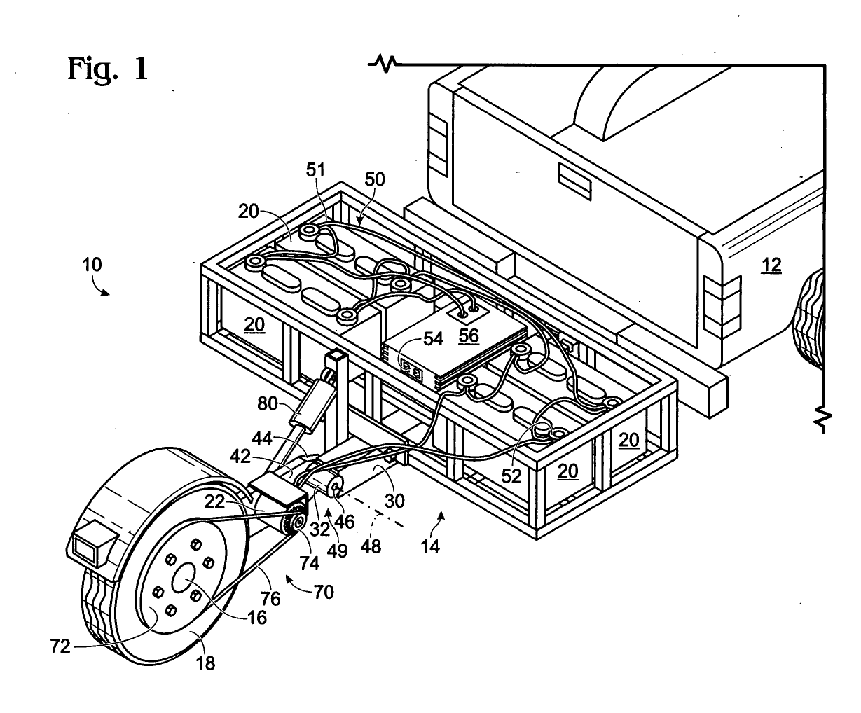

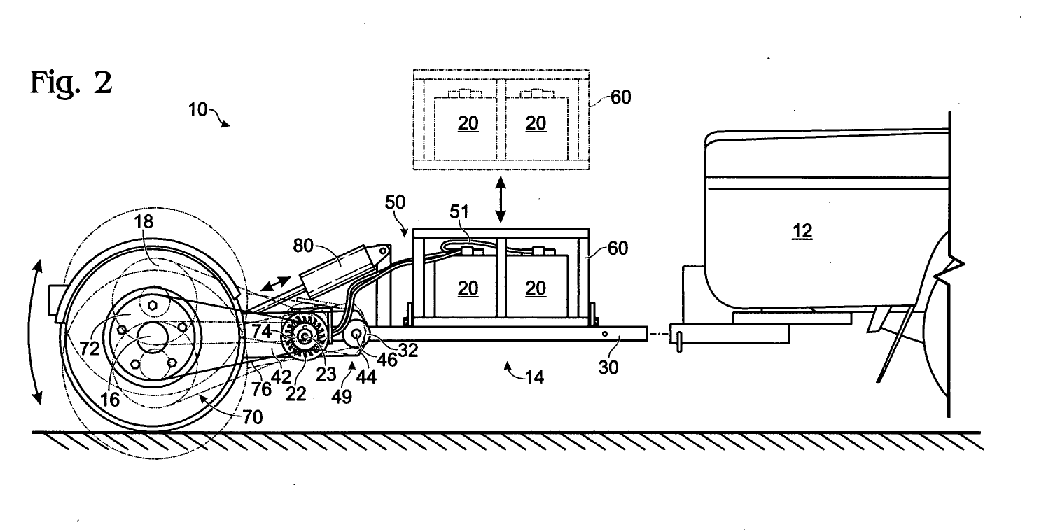

With reference to FIGS. 1 and 2, a mobile energy system 10 is shown attached to a transport 12. Mobile energy system 10 includes a frame 14, an axle 16 supported by frame 14, a wheel 18 mounted for rotation to axle 16, an energy storage device 20 mounted to frame 14, and an electricity generator 22 mounted to frame 14. As described in more detail below, mobile energy system 10 converts the mechanical energy of wheel 18 rotating into electricity with electricity generator 22.

In the example shown in FIGS. 1 and 2, mobile energy system 10 is configured to be towed by transport 12 and to convert a portion of the transportation energy into electricity. In other examples, transport 12 moves system 10 by a mechanism other than by towing or pulling, such as by pushing system 10.

In still other examples, system 10 includes its own propulsion means, such as powered propulsion means or manual propulsion means. Examples of powered propulsion means include an internal combustion engine, an electric motor, or pneumatic propulsion means. Manual propulsion means for use by a person or an animal include pedals, harnesses, and handles for pushing or pulling.

In the example shown in FIGS. 1 and 2, transport 12 is a vehicle. Suitable vehicles include a passenger automobile, a tractor, a semi-trailer truck. In other examples, the transport is an animal or a person. For example, the transport may include a horse, a team of dogs, an jogging athlete, or a bicyclist riding a bike.

Of course, the rate at which electricity is generated and the amount of electricity generated will vary depending on the particular transport used. However, system 10 may be tailored to work effectively with a given transport. For example, system 10 may be tailored for a particular transport by modifying gear ratios used in a transmission linking electricity generator 22 to wheel 18. Additionally or alternatively, an electricity generator with an appropriate resistance for the transport being used may be selected. It is understood that tailoring system 10 to be suitable for a wide range of transports, which inherently have a wide range of power and speed capabilities, is within the skill of those knowledgeable in this field.

Frame 14 provides a rigid structure with mounting points to which the components of system 10 are mounted. In the example shown in FIGS. 1 and 2, frame 14 includes metal girders having a plurality of holes through which bolts or other fasteners may extend through. In other examples, the frame is made from wood, plastic, fiberglass, and combinations thereof. Any frame structure or design suitable to be moved by a particular transport and to support the components of system 10 may be used, such as, for example, conventional trailers, flatbeds, semitrailers, and bicycle trailers.

In the example shown in FIGS. 1 and 2, frame 14 includes a hitch 30 for coupling frame 14 to transport 12. Any hitch design now known or later developed that is suitable for connecting a frame to a given transport may be used. Hitch 30 includes a hitch bearing 32 configured to support a horizontally aligned shaft.

As shown in FIGS. 1 and 2, frame 14 includes or defines a strut 42 having a first end 44 and a second end opposite first end 44. First end 44 of strut 42 includes a horizontal shaft 46 that is pivotally supported by hitch bearing 42. The second end 46 of strut 42 is connected to axle 16.

The hitch and strut configuration just described enables wheel 18 to pivot relative to transport 12 about an axis 48 in the vertical dimension via strut 42 and hitch bearing 32. Strut 42 being able to pivot relative to transport 12 about axis 48 may be advantageous when system 10 is moved over sloped, uneven, or rough surfaces.

The combination of hitch bearing 32 and horizontal shaft 46 shown in FIGS. 1 and 2 are sometimes referred to as simple bearings or a joint member 49. Any structure configured to allow frame 14 and wheel 18 to move vertically relative to transport 12 may be used. For example, rolling element bearings, jewel bearings, fluid bearings, magnetic bearings, and flexure bearings may all be used additionally or alternatively to simple bearings.

In some examples, system 10 includes a sliding vertical bearing that allows for the frame to move vertically relative to transport 12. A sliding vertical bearing may include a vertically mounted sleeve and a rod slidingly disposed within the sleeve. As the frame moves vertically relative to transport 12, the rod slides vertically relative to the sleeve. At least a portion of the rod remains in contact with the sleeve so that the sleeve may exert horizontal pushing or pulling forces on the rod to push or pull system 10 in a horizontal direction.

System 10 may include a lifting device to lift frame 14 and wheel 18 off the ground. For example, a user may desire to lift these components off the ground when traveling over rough roads or when stowing system 10 during periods of non-use. The lifting device may include a hydraulic assembly or a winch. The lifting device may include a servo mechanism selectively lift the wheel and frame.

In some examples, system 10 may include a lateral bearing assembly to allow the frame to pivot relative to transport 12 about a vertical axis. The frame pivoting about a vertical axis might be advantageous when turning is required. A properly oriented simple bearing as described above, or any of a number of ball bearing arrangements, may be used to facilitate the frame pivoting relative to transport 12 about a vertical axis.

As shown in FIGS. 1 and 2, axle 16 is supported by frame 14 and includes a shaft oriented substantially parallel to the ground, or expressed another way, the axle shaft is oriented horizontally. Any known axle design that is compatible with frame 14 and wheel 18 may be used. In some examples, the axle is a rigid member that rotates in a bearing formed in the frame. In the example shown in FIGS. 1 and 2, axle 16 includes a fixed shaft about which an axle bearing rotates. The axle bearing is mechanically coupled to wheel 18 and rotates about the fixed shaft in turn with wheel 18.

As shown in FIGS. 1 and 2, wheel 18 is mounted for rotation to axle 16 and is in contact with the ground. As transport 12 moves system 10, wheel 18 rotates relative to frame 14 by virtue of being in contact with the ground. As shown in FIGS. 1 and 2, wheel 18 may be an automobile tire. However, other tires or wheels may additionally or alternatively be used, such as motorcycle tires, bike tires, tractor tires, stroller wheels, or wagon wheels.

A number of different wheel diameters may be used for wheel 18. The diameter of wheel 18 will effect the rate that wheel 18 rotates for a given linear speed at which transport 12 moves system 10. The rate at which wheel 18 rotates will affect the rate at which electricity generator 18 generates electricity. The relationship between the rate at which wheel 18 rotates and the rate at which electricity generator 18 generates electricity can be modified with a transmission, as described more fully below.

Energy storage device 20 serves to store electricity generated by electricity generator 22. Any device now known or later developed that is suitable for storing electricity may be used. In the example shown in FIGS. 1 and 2, energy storage device is a battery. Any type of battery suitable for the voltage and current operating range of a given electricity generator may be used. For example, 12 volt car batteries, deep cycle recreational vehicle batteries, nickel cadmium batteries, and lithium ion batteries are suitable energy storage devices.

In the example shown in FIGS. 1 and 2, system 10 includes multiple energy storage devices 20. For example, system 10 may include 8 or more energy storage devices. In other examples, system 10 includes less than 8 energy storage devices, such as a single energy storage device. In the example shown in FIGS. 1 and 2, system 10 includes 4 total energy storage devices. In still other examples, system 10 does not include an energy storage device, but instead concurrently utilizes the electricity generated by electricity generator 22 as it is generated.

In the examples shown in FIGS. 1 and 2, system 10 includes circuitry 50 to electrically connect two or more energy storage devices 20 together. In the example shown in FIGS. 1 and 2, circuitry includes wires 51. The circuitry may connect energy storage devices 20 and other electrical components in series or in parallel. In the example shown in FIGS. 1 and 2, circuitry 50 includes an input port 52 that provides an electrical connection to each energy storage device 20. Further, circuitry 50 includes an output port 54 that provides an electrical connection to each energy storage device 20. In some examples, circuitry 50 includes a singe input port and a single output port.

In the example shown in FIGS. 1 and 2, circuitry 50 includes an inverter 56 supported by frame 14 and electrically connected to energy storage device 20. Inverter 56 functions to convert the DC electricity stored in energy storage devices into AC electricity suitable for devices or facilities designed to run on AC power. For example, one application in which system 10 may be used is to supply electricity to a home via the home's main power circuitry. As household appliances, devices, and wiring is designed to operate using AC electricity, inverter 56 is useful to render compatible the DC electricity stored in energy storage device with the household electricity requirements.

Inverter 56 may be fixed to frame 14 or mounted for removal from frame 14. Inverter 56 typically includes a power cord for connecting to an electricity receptacle. An inverter having a rated capacity of 2000 watts continuous power and 4000 watts surge power has been found acceptable for many applications. In some examples, the circuitry does not include and inverter, but is configured to electrically connect energy storage device 20 to an inverter at a given location.

In some applications, system 10 includes a combination of fixed and removable energy storage devices. For example, system 10 may include 8 total energy storage devices, 4 of which are removable and 4 of which are fixed to frame 14. The removable energy storage devices allow the stored energy to be delivered to a location having a need for stored electricity and left at the location while system 10 is moved to a different location. The fixed energy storage devices provide a consistent source of stored electricity on system 10 as they may be constantly recharged when system 10 is moved from location to location.

The distinction between removable and fixed energy storage devices relates to how the devices are mounted to the frame. A removable mounting is a mounting that is designed to allow the end user to easily dismount the energy storage device without substantial disassembly of system 10 or without the need for specialized tools or an extensive number of tools. A fixed mounting more fully integrates the energy storage device to the frame and thus requires more disassembly to remove the energy storage device than with a removable mounting.

Removable mountings may include mountings utilizing latches, snap fittings, sleeves, and bungee cords or other elongate tension bearing member as a selectively removable fastener. Fixed mountings may includes screws, bolts, brackets, and clamps as fasteners. Applicant further contemplates mountings including a combination of removable and fixed characteristics.

As shown in FIG. 2, the frame may include a rack 60 configured for selective removal from the rest of the frame. Rack 60 may support all energy storage devices or may support a subset of them. Rack 60 may be selectively removed from the rest of frame 14 by undoing bolts or other fasteners.

In some examples, the fixed energy storage devices are larger, heavier, and have a higher electricity storage capacity than the removable energy storage devices. However, in some examples there is no distinction between the energy storage devices mounted to frame with a removable mounting and with a fixed mounting.

Electricity generator 22 functions to convert at least a portion of the mechanical energy associated with the rotation of wheel 18 into an electric current for use or storage. Electricity generator 22 is defined to be any device that converts mechanical energy into electric current. Accordingly, electricity generator 22 is broader than a conventional device known in some contexts as a generator, which converts mechanical energy into direct current (“DC”) electricity. Indeed, electricity generator 22 expressly includes other devices, such as alternators, that at least initially convert mechanical energy into alternating current (“AC”) electricity.

In the example shown in FIGS. 1 and 2, electricity generator 22 is an alternator, which is configured to output DC electricity. Any alternator now known or later developed that is suitable in size, shape, and operation for mounting on frame 14 and for mechanically coupling to wheel 18 may be used. The alternator shown in FIGS. 1 and 2 initially generates AC electricity and includes diodes to output DC electricity at 12V. However, an alternator outputting AC electricity or outputting electricity at any voltage may be used with appropriate downstream components, such as AC to DC converters.

In the example shown in FIGS. 1 and 2, the DC electricity generated in the alternator is stored as voltage potential energy in energy storage device 20. In some examples, system 10 includes a regulator to deactivate the alternator when one or more energy storage devices have reached their full charge. The regulator may be operatively connected to the alternator in any known manner.

In some examples, the electricity is directly utilized by a device designed to run on DC electricity. In other examples, the DC electricity is converted to AC electricity with an inverter and then utilized by an AC powered device. As is well known in the art, appropriate gauge wires may be used as necessary to conduct the electricity generated by electricity generator 22 to energy storage device 20 or to devices directly utilizing the electricity.

In the example shown in FIGS. 1 and 2, electricity generator 22 is mechanically connected to the axle bearing via a transmission 70. In this manner, electricity generator 22 is mechanically connected to wheel 18 via transmission 70 and the axle bearing. Expressed another way, electricity generator 22 is drivingly connected to wheel 18.

Transmission 70 includes a drive gear 72 coupled to the axle bearing, a driven gear 74 coupled to a rotor shaft 23 of the alternator, and a linkage 76 linking rotation of drive gear 72 to rotation of driven gear 74. In transmission 70 shown in FIGS. 1 and 2, linkage 76 is a belt. However, in other examples, the linkage is a chain. Any member or device suitable for linking rotation of drive gear 72 with rotation of driven gear 76 may serve as the linkage. The configuration of transmission 70 shown in FIGS. 1 and 2 is sometimes referred to as a pulley-and-belt transmission.

Transmission 70 functions to transfer at least a portion of the rotational energy of wheel 18 to electricity generator 22. In the example shown in FIGS. 1 and 2, transmission 70 governs the rate at which rotor shaft 23 rotates for a given rotation speed of wheel 18. The speed at which driven gear 74 rotates, and accordingly the speed at which rotor shaft 23 rotates, will govern the rate of electricity generated by the alternator.

The larger diameter of drive gear 72 relative to driven gear 74 causes driven gear 74 to rotate faster than drive gear 72. In some examples, drive gear 72 has a diameter approximately 4.8 times the diameter of driven gear 74. However, many other gear diameter ratios may be used as applicable. In some examples, drive gear 72 has a diameter equal to or smaller than the diameter of driven gear 74.

As shown in FIGS. 1 and 2, system 10 includes a biasing mechanism 80 to bias wheel 18 into contact with the ground. Biasing mechanism 80 shown in FIGS. 1 and 2 is a gas charged shock with an internal spring, but any suitable biasing mechanism may be used. In other examples, the biasing mechanism is a spring or a resilient member such as a bungee cord.

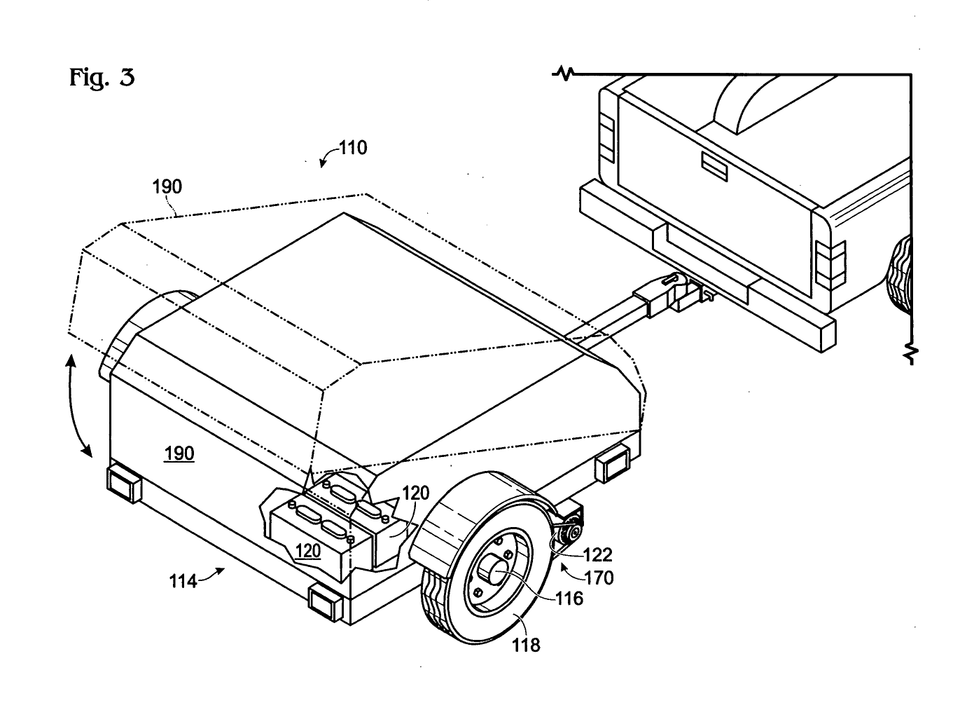

Turning attention to FIG. 3, a second example of a mobile energy system 110 will now be described. Mobile energy system 110 includes many similar or identical features to mobile energy system 10. Thus, for the sake of brevity, each feature of mobile energy system 110 will not be redundantly explained. Rather, key distinctions between mobile energy system 110 and mobile energy system 10 will be described in detail and the reader should reference the discussion above for features substantially similar between the two systems.

As can be seen in FIG. 3, mobile energy system 110 includes a frame 114, an axle 116 supported by frame 114, and a first wheel 118. System 110 further includes a second wheel, which is obscured from view by frame 114, opposite first wheel 118. System 110 includes energy storage devices 120 mounted to frame 114 and a first electricity generator 122 mounted to frame 114. Further, system 110 includes a second electricity generator, which is obscured from view by frame 114, mounted to frame 114 and drivingly connected to the second wheel.

Frame 114 has a different configuration than frame 14, but serves the same basic purpose to support the components of system 110. Frame 114 provides a comparatively larger support area than frame 14, which enables it to support more components or cargo. The materials and manner of construction of frame 114 may be substantially similar to those described above for frame 14.

As is apparent from FIG. 3, axle 116 is configured to support two wheels as compared to axle 16, which is configured to support a single wheel. However, axle 116 is substantially similar to axle 16 except that it includes a first axle bearing and a second axle bearing spaced apart from the first axle bearing. First and second axle bearings rotate about a shaft extending between them.

First and second wheels may enable system 110 to support more weight than system 10. Increased weight capacity allows more energy storage devices to be supported and/or heavier accessories, such as inverters, regulators, wiring, and the like, to be supported. Further, first and second wheels may provided improved stability and weight distribution.

System 110 includes first and second electricity generators to enable increased electricity generation as compared to system 10, which includes a single electricity generator. First electricity generator 122 is mechanically coupled to first wheel 118 via a first transmission 170 and the second electricity generator is mechanically coupled to the second wheel via a second transmission.

First and second electricity generators may be engaged to generate electricity concurrently or may be engaged at different times. For example, first electricity generator 122 may be engaged with first wheel 118 to generate electricity for a given period of time. During that given period of time, the second electricity generator may be disengaged. At some specified time or upon some predetermined event, first electricity generator 118 may be disengaged and the second electricity generator may be engaged. In some examples, both electricity generators are engaged at the same time. In other examples, one electricity generator serves a primary electricity generating role while the other electricity generator serves as a backup in case the primary electricity generator malfunctions.

First and second electricity generators may each be electrically connected to all energy storage devices 120. Alternatively, first electricity generator 122 may be electrically connected to a first subset of energy storage devices while the second electricity generator is electrically connected to a second subset of energy storage devices. In some examples, a first subset of energy storage devices is characterized as fixed energy storage devices while the second subset is characterized as removable energy storage devices.

First and second transmissions may have the same or different gearing ratios. The same or different gearing ratios enable the transmissions to rotate components of their respective electricity generators, such as rotor shafts, at the same or different rates for a given wheel rotation rate. Rotating components of each electricity generator at a different rate may optimize the rate at which electricity is generated for each electricity generator or electrically connected component, such as an energy storage device.

System 110 may include an inverter for converting DC electricity stored in energy storage devices 120 into AC current suitable for use in homes or with AC powered devices. Regulators, wiring, circuitry, and all other associated electrical and mechanical components described above with regard to system 10 may also be included in system 110.

System 110 includes a cover 190 to protect the components of system 110 from the elements and to render system 110 more aerodynamic. Any cover suitable for substantially isolating the components from rain, snow, wind, and dirt may be used. Fiberglass, plastic, metal, and wood are all suitable materials for cover 190. The cover may be formed into an aerodynamic shape to reduce friction when system 110 is being moved.

In the example shown in FIG. 3, cover 190 is configured to pivot open and closed. In the open position, the internal components are accessible to the user. In the closed position, the internal components are protected from the elements and from theft and vandalism. A lock may be provided to prevent cover 190 from being pivoted open without authorization.

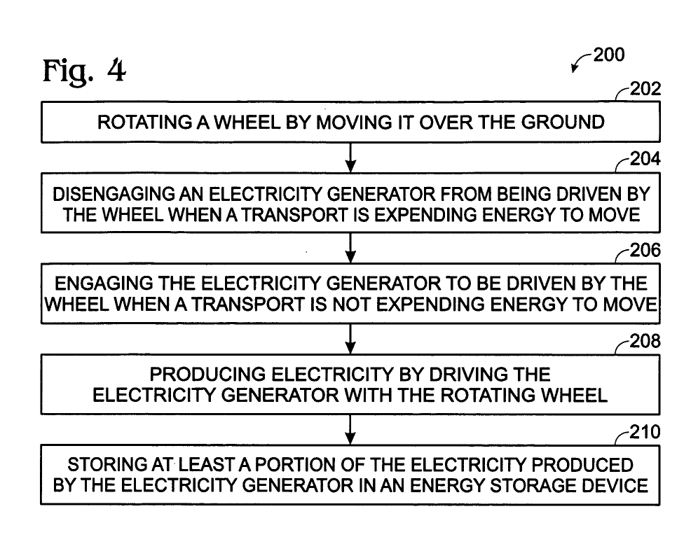

Turning attention to FIG. 4, a mobile energy method 200 will now be described. Mobile energy method 200 provides a method of generating and storing electricity with an electricity generator drivingly connected to a wheel in contact with the ground. Method 200 includes rotating a wheel by moving it along the ground at step 202, disengaging an electricity generator from being driven by the wheel when a transport is expending energy to move at step 204, and engaging the electricity generator to be driven by the wheel when the transport is not expending energy to move at step 206. Method 200 further includes producing electricity as the wheel rotates by driving an electricity generator at step 208 and storing at least a portion of the electricity produced by the electricity generator in an energy storage device at step 210.

Rotating a wheel by moving it along the ground at step 202 may be accomplished by towing a wheel behind a transport, such as a vehicle, person, or animal. Additionally or alternatively, rotating a wheel at step 202 may be accomplished by pushing or otherwise moving the wheel along the ground. In some examples, the wheel is incorporated into a trailer connected to a vehicle or other transport to enable the wheel to be rotated by moving the trailer with the transport.

Method 200 includes the optional step of disengaging an electricity generator from being driven by the wheel when a transport is expending energy to move at step 204. In some method examples, the electricity generator is constantly connected to wheel such that it is always driven by the wheel as it rotates. However, it may be desirable to only extract energy from the rotating wheel when the transport is not expending energy to move the wheel along the ground.

For example, the electricity generator may be disengaged from the wheel at step 204 when the transport is moving the wheel uphill or accelerating the wheel along the ground as both of these activities require the transport to expend energy. Further, the electricity generator may be disengaged from being driven by the wheel when the transport is moving the wheel over flat ground at a constant velocity as the transport has to expend a certain amount of energy to overcome the force of friction between the wheel and the ground.

Method 200 includes the further optional step of engaging the electricity generator to be driven by the wheel when the transport is not expending energy to move at step 206. In some examples, electricity generator is engaged to be driven by the wheel when the transport is moving the wheel downhill or when the transport braking or otherwise reducing its velocity. Appropriate sensors to determine when the transport is expending energy or traveling downhill may be provided.

Producing electricity as the wheel rotates by driving an electricity generator at step 208 may include rotating components of the electricity generator with at least a portion of the rotational energy of the rotating wheel. In some examples, the electricity generator is drivingly connected to the wheel, such as through a transmission or other mechanical linkage. In such examples, rotating the wheel at step 202 rotates a component of the electricity generator, such as a rotor shaft, to produce electricity.

In other examples, producing electricity as the wheel rotates by driving an electricity generator at step 208 includes translating components of the electricity generator. For example, electricity generator may be a linear electricity generator designed to produce electricity in response to linear motion of a stator. Appropriate mechanical gearing to convert rotational energy from the rotating wheel into linear motion of a linear stator may be provided.

Storing at least a portion of the electricity produced by the electricity generator in an energy storage device at step 210 may be accomplished by electrically connecting the electricity generator to the energy storage device. The energy storage device may be a battery or a plurality of batteries. In some examples, storing the electricity at step 210 includes converting AC electricity to DC electricity. Additionally or alternatively, storing the electricity at step 210 may include electrically disconnecting the electricity generator from the energy storage device when the energy storage device is unable to safely store more electricity.

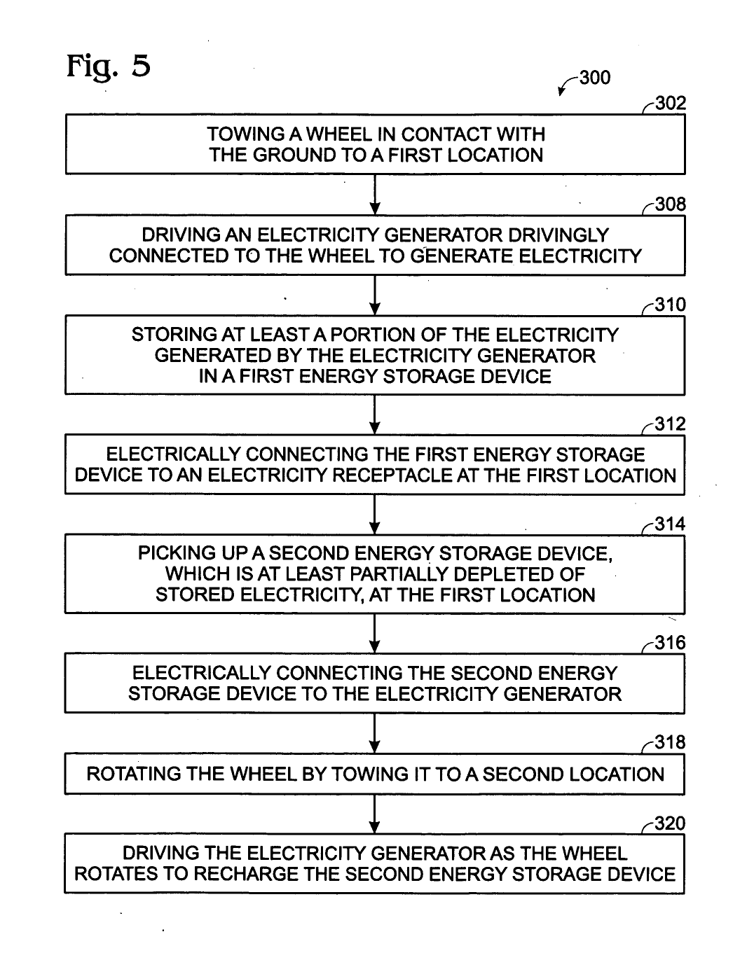

Turning attention to FIG. 5, a mobile energy method 300 will now be described. Mobile energy method 300 provides a method of distributing electricity to different locations. Method 300 includes towing a wheel in contact with the ground to a first location at step 302, driving an electricity generator drivingly connected to the wheel to generate electricity at step 308, and storing at least a portion of the electricity generated by the electricity generator in a first energy storage device at step 310, and electrically connecting the first energy storage device to an electricity receptacle at the first location at step 312. Method 300 further includes picking up a second energy storage device at step 314, electrically connecting the second energy storage device to the electricity generator at step 316, rotating the wheel by towing it to a second location at step 318, and driving the electricity generator as the wheel rotates to recharge the second energy storage device at step 320.

Steps 302, 308, and 310 of method 300 are substantially similar to steps 202, 208, and 210 as described above in connection with method 200. Thus, these steps will not be described again in detail.

At step 312, electrically connecting the first energy storage device to an electricity receptacle at the first location may be accomplished by plugging in a wire electrically connected to the energy storage device to the electricity receptacle. Additionally or alternatively, electrically connecting the first energy storage device to an electricity receptacle at step 312 may include converting DC electricity from the energy storage devices into AC electricity. Converting the DC electricity to AC electricity may be accomplished by any known means, such as by interconnecting an inverter. In some examples, electrically connecting the first energy storage device to an electricity receptacle at step 312 includes removing the energy storage device from a cart or trailer used to transport the energy storage device to the first location.

Method 300 includes the optional step of picking up a second energy storage device at step 314. The second energy storage device may be located at the first location and may be at least partially depleted of stored electricity. In some examples, picking up a second energy storage device at step 314 includes replacing or “swapping” the first energy storage device, which may be fully charged, for the second energy storage device, which may be spent or depleted. In other examples, the second energy storage device is simply picked up without leaving a fully charged energy storage device behind.

Method 300 includes optional steps 316, 318 and 320 to recharge the second energy storage device. At step 316, the second energy storage device may be electrically connected to the electricity generator by any conventional means. For example, the two components may be electrically connected with wires or by placing electrical contacts of the second energy storage device in physical contact with electrical contacts of the electricity generator or with wires connected to the electrical contacts of the electricity generator.

Rotating the wheel by towing it to a second location at step 318 is substantially similar to step 302 and step 202 of method 200, except that the wheel is towed to a second location. Driving the electricity generator as the wheel rotates to recharge the second energy storage device at step 320 is substantially similar to steps 308 and 310 and 208 and 210 of method 200, except that the electricity generated by the electricity generator is stored in the second energy storage device rather than in the first energy storage device.

It is believed that the disclosure set forth above encompasses multiple distinct inventions with independent utility. While each of these inventions has been disclosed in a particular form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it is within the scope of the present inventions that such disclosure or claims may be understood to include incorporation of one or more such elements, neither requiring nor excluding two or more such elements.

Applicant reserves the right to submit claims directed to certain combinations and subcombinations that are directed to one or more of the disclosed inventions and that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to a different invention or directed to the same invention, whether different, broader, narrower or equal in scope to the original claims, are also regarded as included within the subject matter of the inventions of the present disclosure.

1. A mobile energy system, comprising:
a frame;
an axle supported by the frame and oriented substantially parallel to the ground;
a wheel mounted to the axle and in contact with the ground, the wheel being configured rotate about the axle when the frame translates relative to the ground;
an energy storage device supported by the frame;
an electricity generator operatively connected to the wheel and electrically connected to the energy storage device, the electricity generator being driven by rotation of the wheel and generating electricity when driven.

2. The mobile energy system of claim 1, wherein the electricity generator comprises an alternator.

3. The mobile energy system of claim 1, wherein the wheel comprises a first wheel and a second wheel spaced from the first wheel.

4. The mobile energy system of claim 3, wherein the electricity generator comprises:
a first electricity generator operatively connected to the first wheel; and
a second electricity generator operatively connected to the second wheel.

5. The mobile energy system of claim 1, further comprising an inverter electrically connected to the energy storage device and configured to invert direct current from the energy storage device into alternating current.

6. The mobile energy system of claim 1, wherein the frame includes a hitch configured to mechanically connect the frame to a transport.

7. The mobile energy system of claim 1, wherein the frame includes:
a strut having a first end and a second end opposite the first end, the second end being connected to the axle; and
a joint member connected to the first end of the strut, the joint member being configured to allow the strut to move relative to the ground in at least one dimension.

8. The mobile energy system of claim 7, wherein:
the joint member includes a bearing configured to support a horizontal shaft and to enable the horizontal shaft to rotate; and
the strut is connected to the horizontal shaft to enable the strut to pivot vertically as the horizontal shaft rotates in the bearing.

9. The mobile energy system of claim 1, further comprising a transmission mechanically connecting the wheel to the electricity generator at a selected gear ratio.

10. The mobile energy system of claim 9, wherein the selected gear ratio is defined by a drive gear operatively connected to the wheel and a driven gear connected to the electricity generator and linked to the drive gear with a linkage, the drive gear having a larger diameter than the driven gear.

11. The mobile energy system of claim 9, wherein the transmission includes a pulley and a belt.

12. The mobile energy system of claim 1, wherein the energy storage device is comprised of a plurality of energy storage devices supported on the frame.

13. The mobile energy system of claim 12, further comprising circuitry to electrically connect the plurality of energy storage devices.

14. The mobile energy system of claim 13, wherein the circuitry includes a single output port that provides an electrical connection to each of the plurality of energy storage devices.

15. A method of generating and storing electricity with an electricity generator drivingly connected to a wheel in contact with the ground, the method comprising the steps of:
rotating the wheel by moving it along the ground;
producing electricity as the wheel rotates by driving the electricity generator; and
storing at least a portion of the electricity produced by the electricity generator in an energy storage device.

16. The method of claim 15, further comprising disengaging the electricity generator from being driven by the wheel when a transport is expending energy to move the wheel along the ground.

17. The method of claim 16, further comprising engaging the electricity generator to be driven by the wheel when the transport is not expending energy to move the wheel along the ground.

18. The method of claim 17 wherein the electricity generator is driven by the wheel only when the transport is braking.

19. A method of distributing electricity, comprising:
towing a wheel in contact with the ground to a first location;
driving an electricity generator drivingly connected to the wheel to generate electricity;
storing at least a portion of the electricity generated by the electricity generator in a first energy storage device; and
electrically connecting the first energy storage device to an electricity receptacle at the first location.

20. The method of claim 19, further comprising:
picking up a second energy storage device, which is at least partially depleted of stored electricity, at the first location;
electrically connecting the second energy storage device to the electricity generator;
rotating the wheel by towing it to a second location; and
driving the electricity generator as the wheel rotates to recharge the second energy storage device.
